(19) United States
(12) Patent Application Publication
(10) Pub. No.: US 2019/0260242 A1
(43) Pub. Date: Aug. 22, 2019

(54) ROTARY ELECTRIC MACHINE

(71) Applicant: HONDA MOTOR CO., LTD., Tokyo (JP)

(72) Inventor: Yoshihisa KUBOTA, Wako-shi, Saitama (JP)

(21) Appl. No.: 16/280,138

(22) Filed: Feb. 20, 2019

(30) Foreign Application Priority Data
Feb. 22, 2018 (JP) 2018-029270

(51) Int. Cl. H02K 1/16; H02K 1/27; H02K 21/14

(52) U.S. Cl. CPC H02K 1/165; H02K 29/03; H02K 21/14; H02K 1/276

(57) ABSTRACT

Provided is a rotary electric machine such that the torque ripple is decreased and the pulsation during low-speed operation and the noise and vibration during high-speed operation thus become smaller. This interior permanent magnet rotary electric machine includes a stator having a plurality of teeth, slots, and coils at one pole, wherein the length of one of the teeth from a bottom of each slot to a tip of the one tooth differs from the length of another tooth.

### TECHNICAL FIELD

The present invention relates to a rotary electric machine.

### BACKGROUND ART

Of vehicle driving motors, IPM (Interior Permanent Magnet) synchronous motors have been widely used. Recent motor control technologies have thus been increasingly improved to achieve smooth driving.

Unfortunately, torque generated by the motor itself of each IPM synchronous motor is accompanied by a torque ripple (torque pulsation) due to its structure. This constitutes one of causes for pulsation during low-speed driving and noise and vibration during high-speed driving.

As a method for reducing this torque ripple, JP5433198B, for instance, discloses a method in which both side sections beside a magnet at every other rotor magnetic pole on a rotor surface are each provided with a gap. This method includes: providing gaps at every other pole to reduce a torque ripple by just using the gaps such that the phase of a torque ripple waveform caused by a pole with gaps counteracts the inverted phase of a torque ripple waveform caused by a pole without any gaps.

### SUMMARY OF INVENTION

### Technical Problem

Unfortunately, the pulsation reduction by the gaps on the outer circumference of the rotor as described in JP5433198B alone still causes pulsation during low-speed driving and noise and vibration during high-speed driving because of the remaining torque ripple. Thus, the torque ripple should be further reduced.

Here, the objective of the present invention is to provide a rotary electric machine such that the torque ripple is further reduced.

### Solution to Problem

Embodiments of the present application provides a rotary electric machine comprising

a stator having a plurality of teeth, slots, and coils at one pole,

wherein a length of one of the teeth from a bottom of each slot to a tip of the one tooth differs from a length of another tooth.

In addition, other solutions will be described in the Description of Embodiments.

### Advantageous Effects of Invention

The present invention makes it possible to provide a rotary electric machine having a reduced torque ripple.

### BRIEF DESCRIPTION OF DRAWINGS

FIG. 1 is a diagram illustrating the configuration and structure of a plurality of teeth at one pole in a stator of a rotary electric machine according to a first embodiment of the present invention.

FIG. 2 is a diagram illustrating how the stator and a rotor are arranged at one pole in the rotary electric machine with six pole pairs according to the first embodiment of the present invention.

FIG. 3 is a graph showing the permeance distribution across 360 degrees of electric angle in vicinity of the teeth at one pole in the stator of the rotary electric machine according to the first embodiment of the present invention.

FIG. 4 is a graph showing the torque characteristic of the rotary electric machine according to the first embodiment of the present invention and the torque characteristic of a rotary electric machine according to a comparative embodiment.

FIG. 5 is a diagram illustrating the configuration and structure of a plurality of teeth at one pole in a stator of the rotary electric machine with six pole pairs according to the comparative embodiment.

FIG. 6 is a diagram illustrating how the stator and a rotor are arranged at one pole in the rotary electric machine with six pole pairs according to the comparative embodiment.

FIG. 7 is a graph showing the permeance distribution across 360 degrees of electric angle in vicinity of the teeth at one pole in the stator of the rotary electric machine according to the comparative embodiment.

FIG. 8 is a graph showing torque and a torque ripple waveform across 360 degrees of electric angle in the rotary electric machine according to the comparative embodiment.

### DESCRIPTION OF EMBODIMENTS

Hereinafter, embodiments of the present invention (hereinafter, referred to as embodiments) are suitably described in detail with reference to the Drawings.

(Rotary Electric Machine According to First Embodiment)

### <Structure of Stator Teeth (Teeth)>

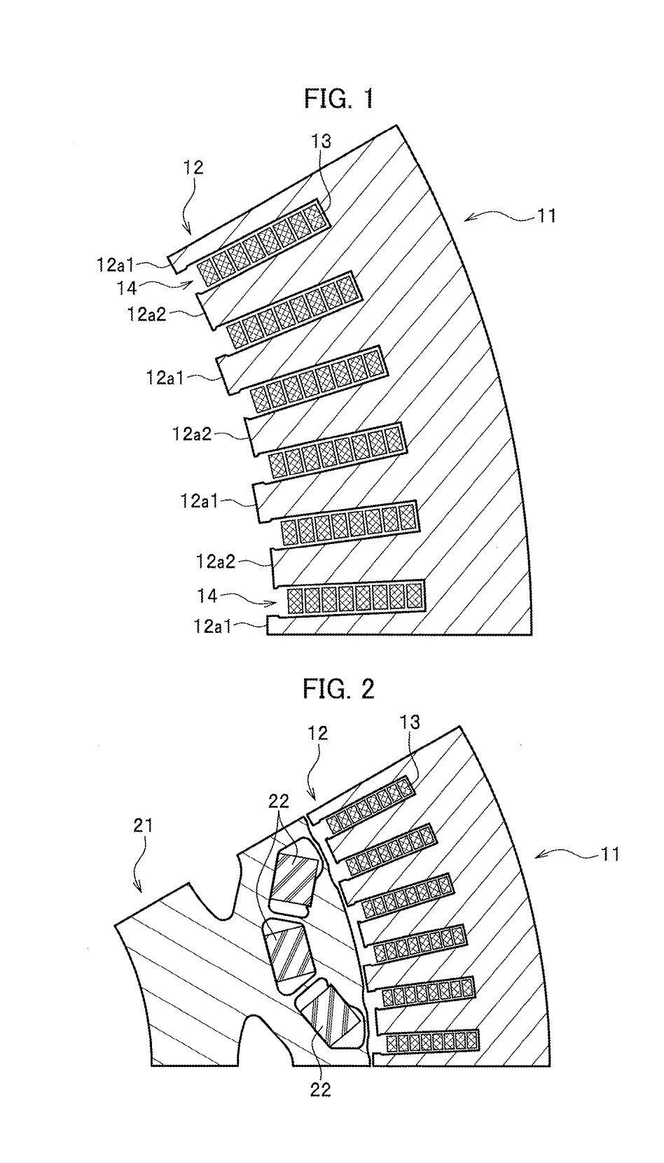

With reference to FIGS. 1 and 2, the following describes the configuration and structure of stator teeth (suitably called “teeth”) included in a rotary electric machine according to a first embodiment of the present invention.

FIG. 1 is a diagram illustrating the configuration and structure of a plurality of teeth 12 (12a1 and 12a2) at one pole in a stator 11 of the rotary electric machine according to the first embodiment of the present invention.

In addition, FIG. 2 is a diagram illustrating how the stator 11 and a rotor 21 are arranged at one pole in the rotary electric machine with six pole pairs according to the first embodiment of the present invention. FIG. 2 shows that a plurality of permanent magnets 22 are embedded in the rotor 21. In addition, each coil (winding) 13 is a distributed winding and is stored in each slot 14. They are included in the stator 11.

Note that FIG. 2 illustrates how the stator 11 and the teeth 12 of FIG. 1 are arranged. Then, the detailed description is omitted accordingly.

In FIG. 1, the stator 11 has the plurality of teeth 12, coils 13, and slots 14. One pole of the stator 11 is provided with six teeth 12 (12a1 and 12a2).

Each tooth 12 designated as “12a1” and each tooth 12 designated as “12a2” in FIG. 1 are alternately arranged. Note that the “a1” and “a2” of the “12a1” and the “12a2” reflect the inner diameter R (a1 and a2) sizes of the teeth, respectively. That is, the size of each tooth 12a1 differs from the size of each tooth 12a2.

As shown in FIG. 1, the same form of each tooth 12 (12a1 or 12a2) is arranged every other one. This alternate arrangement of the teeth 12a1 and the teeth 12a2 affects the operating characteristics of the rotary electric machine.

Note that the inner diameter of each tooth 12 means the size (distance, length) from the central axis of the stator 11 (or the rotor 21) to a tip (an end proximal to the rotor 21) of each tooth 12.

However, in FIGS. 1 and 2, the central axis is not depicted, so that the inner diameter R size is indefinite in FIGS. 1 and 2. Because of this, the size (distance, length) from the bottom (an end distal to the rotor 21) of each slot 14 to the tip of each tooth 12 is suitably used as a reference to the length of each tooth 12.

When the size is designated as above, the “inner diameter size of each tooth 12” and the “size from the bottom of each slot 14 to the tip of each tooth 12” differ from each other in size. The size relationship therebetween is opposite but can still indicate the difference in the length between the teeth. Accordingly, when the difference in the length between the teeth is indicated, the above designation, whichever is suitable, is used.

### Operating Characteristics of Rotary Electric Machine According to First Embodiment of the Present Invention

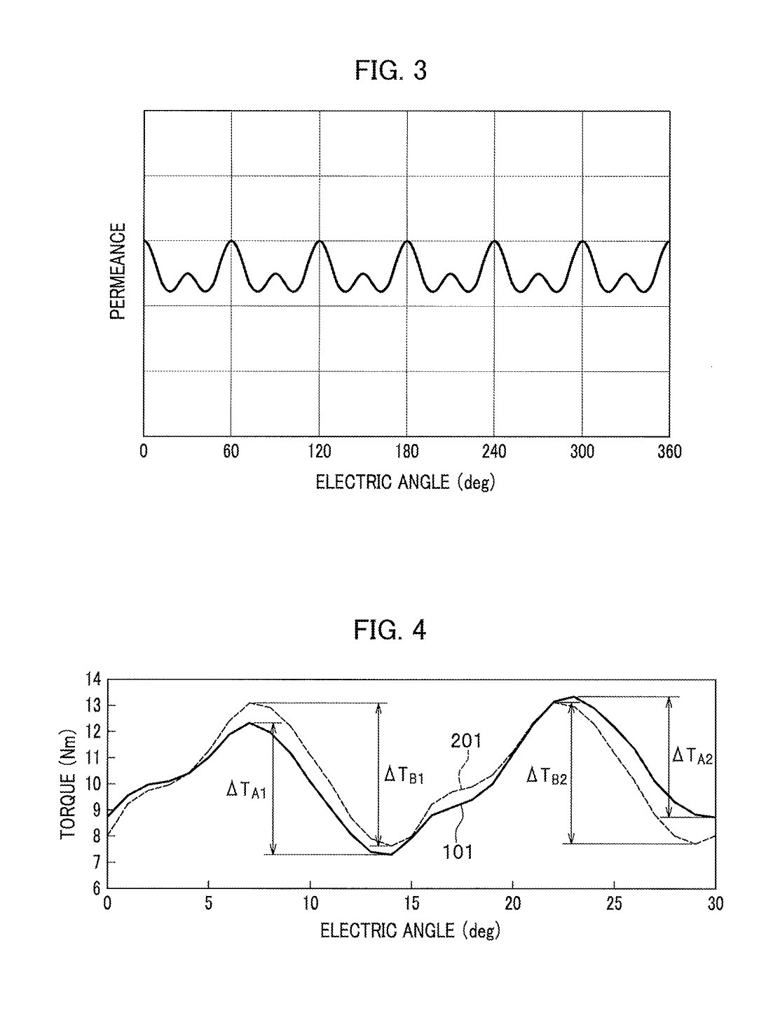

With reference to FIGS. 3 to 4, the following describes the operating characteristics of the rotary electric machine according to the first embodiment of the present invention.

FIG. 3 is a graph showing the permeance distribution across 360 degrees of electric angle in vicinity of the teeth 12 at one pole in the stator 11 of the rotary electric machine according to the first embodiment of the present invention. In FIG. 3, the ordinate represents a permeance (represented in, for instance, “WbA⁻¹”), which indicates how easy the magnetic flux penetrates; and the abscissa represents an electric angle (deg: degrees), which reflects a position of the stator including the teeth.

According to the rotary electric machine of FIG. 3 involving the first embodiment of the present invention, the inner diameter R sizes (a1 and a2) of the teeth 12 are arranged alternately. This causes the spatial permeance distribution, which indicates how easy the magnetic flux penetrates, to change every 60 degrees.

Specifically, the 12th-order peak is diminished every single tooth, so that the 12th-order permeance fluctuation is alleviated. As shown in FIG. 3, in the spatial distribution indicating how easy the magnetic flux penetrates, the fluctuation of the corresponding 12th-order component across electric angle degrees is small. As a result, the magnetic pulsation becomes smaller. This enables the torque ripple to decrease in the rotary electric machine.

FIG. 4 is a graph showing both the torque characteristic of the rotary electric machine according to the first embodiment of the present invention and the torque characteristic of a rotary electric machine according to the below-described comparative embodiment.

In FIG. 4, the ordinate represents torque (Nm) and the abscissa represents an electric angle (deg). The torque characteristic 101 denoted by the solid line indicates a characteristic of the rotary electric machine according to the first embodiment of the present invention. The torque characteristic 201 denoted by the dashed line indicates a characteristic of the rotary electric machine according to the below-described comparative embodiment. In addition, ΔT_{A1} and ΔT_{A2} each indicate the fluctuation width of torque of the rotary electric machine according to the first embodiment of the present invention. Then, ΔT_{B1} and ΔT_{B2} each indicate the fluctuation width of torque of the rotary electric machine according to the below-described comparative embodiment.

The characteristics and effects of the rotary electric machine according to the first embodiment of the present invention as shown in FIGS. 3 and 4 may be more easily understood when compared to those of the rotary electric machine according to the comparative embodiment. Because of this, the following illustrates the rotary electric machine according to the comparative embodiment. Then, FIGS. 3 and 4 are described again in detail in the section <Comparison of Operating Characteristics between Rotary Electric Machine According to First Embodiment of the Present Invention and Rotary Electric Machine According to Comparative Embodiment>.

### Rotary Electric Machine According to Comparative Embodiment

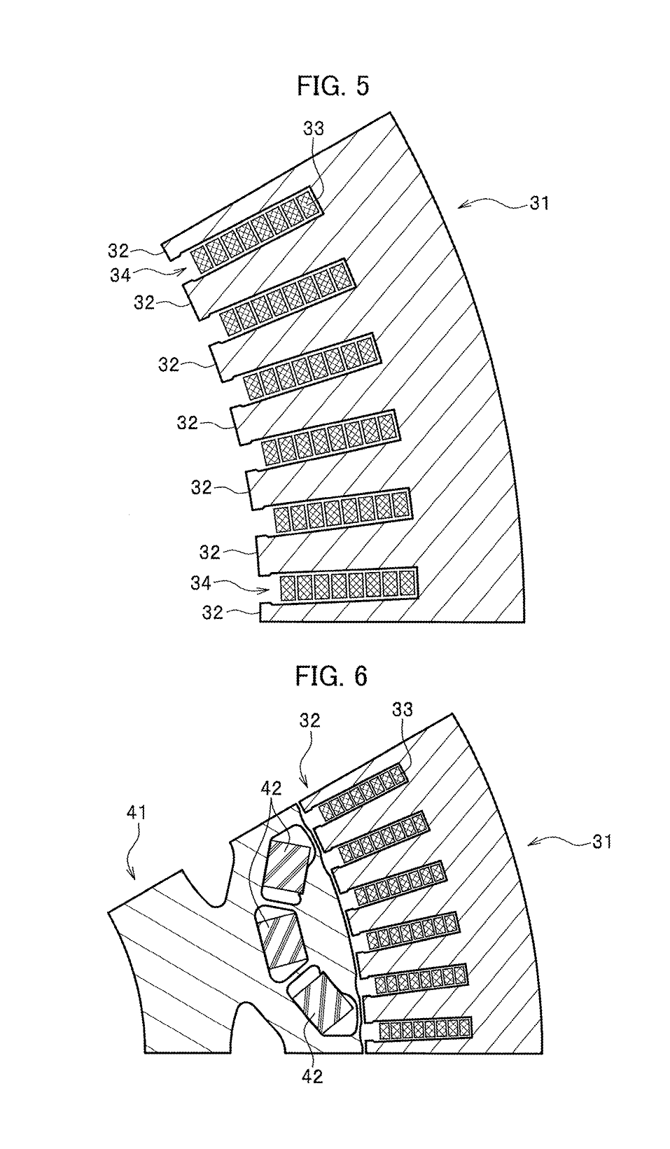

With reference to FIGS. 5 to 6, the following describes the configuration and structure of teeth of the rotary electric machine according to the comparative embodiment in which the teeth have a form different from those of the first embodiment of the present invention.

FIG. 5 is a diagram illustrating the configuration and structure of a plurality of teeth 32 at one pole in a stator 31 of the rotary electric machine with six pole pairs according to the comparative embodiment.

FIG. 6 is a diagram illustrating how the stator 31 and a rotor 41 are arranged at one pole in the rotary electric machine with six pole pairs according to the comparative embodiment. FIG. 6 shows that a plurality of permanent magnets 42 are embedded in the rotor 41. In addition, each coil 33 is a distributed winding and is stored in each slot 34. They are included in the stator 31.

FIGS. 5 and 6, which illustrate the rotary electric machine according to the comparative embodiment, show that the structure of the teeth 32 is different from that of the rotary electric machine according to the first embodiment of the present invention as shown in FIGS. 1 and 2.

FIGS. 5 and 6 show that the six teeth 32 at one pole in the stator 31 have the same inner diameter size and form. That is, the difference from the rotary electric machine according to the first embodiment of the present invention involves the point where the inner diameters of the six teeth 32 are alternately given in FIGS. 1 and 2.

### Operating Characteristics of Rotary Electric Machine According to Comparative Embodiment

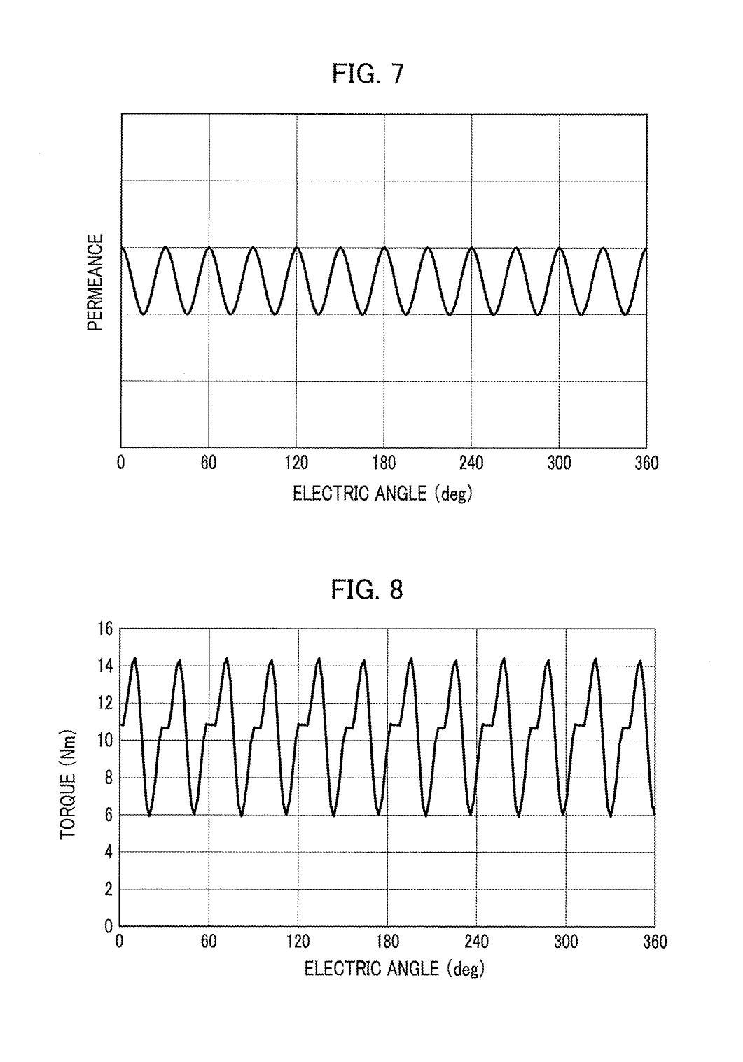

With reference to FIGS. 7 to 8, the following describes the operating characteristics of the rotary electric machine according to the comparative embodiment.

FIG. 7 is a graph showing the permeance distribution across 360 degrees of electric angle in vicinity of the teeth 32 at one pole in the stator 31 of the rotary electric machine according to the comparative embodiment.

In FIG. 7, the ordinate represents a permeance, which indicates how easy the magnetic flux penetrates; and the abscissa represents an electric angle (deg), which reflects a position of the stator including the teeth.

All the teeth 32 arranged in the rotary electric machine according to the comparative embodiment of FIG. 7 have the same shape. This causes the spatial permeance distribution to change every 30 degrees.

FIG. 8 is a graph showing torque and a torque ripple waveform across 360 degrees of electric angle in the rotary electric machine according to the comparative embodiment.

In FIG. 8, the ordinate represents torque (Nm) and the abscissa represents an electric angle (deg).

FIG. 6, which illustrates the comparative embodiment, shows that the armature structure of the stator involves an interior permanent magnet (IPM-type) motor having distributed windings. When the stator has six teeth at one pole, the number of occurrence of magnetic fluctuations is twice the number of the teeth across 360 degrees of electric angle. Accordingly, the 12th-order torque ripple component over the electric angle is likely to occur.

As described above, FIG. 8 shows a torque ripple waveform across 360 degrees of electric angle and demonstrates the occurrence of the 12th-order torque ripple component over the electric angle.

Note that in the case of the rotary electric machine having six pole pairs as shown in FIG. 6, the electric angle 12th-order torque ripple component is the mechanical angle rotation 72th-order ripple component. This component is a high frequency sound and is likely to be noise in a frequency band range that gives people discomfort.

### Comparison of Operating Characteristics Between Rotary Electric Machine According to First Embodiment of the Present Invention and Rotary Electric Machine According to Comparative Embodiment

Next, compared are operating characteristics between the rotary electric machine according to the first embodiment of the present invention and the rotary electric machine according to comparative embodiment.

As described above, FIG. 7 is a graph showing the permeance distribution in the stator of the rotary electric machine according to the comparative embodiment; and FIG. 3 is a graph showing the permeance distribution in the stator of the rotary electric machine according to the first embodiment of the present invention.

The permeance distribution of FIG. 3 is compared to that of FIG. 7. In FIG. 3, the 12th-order permeance fluctuation is alleviated and decreased.

Specifically, in FIG. 7, there are 12 permeance peaks across 360 degrees, but in FIG. 3, there are 6 permeance peaks across 360 degrees. This indicates reduction of the number of peaks.

That is, when compared to the rotary electric machine according to the comparative embodiment, the 12th-order permeance fluctuation is decreased in the rotary electric machine according to the first embodiment of the present invention (FIG. 3 shows its permeance distribution).

As described previously, this 12th-order permeance fluctuation is decreased because the 12th-order peak is diminished every single tooth in the stator of the rotary electric machine according to the first embodiment of the present invention. That is, this is because each tooth 12a1 and each tooth 12a2, which have different sizes, are arranged alternately.

In addition, the rotary electric machine according to the first embodiment of the present invention has a smaller 12th-order fluctuation over the electric angle at one pole. This enables the torque ripple (magnetic pulsation) to decrease in the whole rotary electric machine.

Further, in FIG. 4, compared are the torque characteristic 101 of the rotary electric machine according to the first embodiment of the present invention and the torque characteristic 201 of the rotary electric machine according to the comparative embodiment.

In FIG. 4, the fluctuation width ΔT_{A1} of the torque characteristic 101 across 0 to 15 degrees of electric angle is smaller than the fluctuation width ΔT_{B1} of the torque characteristic 201. In addition, the fluctuation width ΔT_{A2} of the torque characteristic 101 across 20 to 30 degrees of electric angle is smaller than the fluctuation width ΔT_{B2} of the torque characteristic 201.

Here, the electric angle 12th-order torque ripple (permeance distribution) component corresponds to the mechanical angle rotation 72th-order (6 pole pairs×12 orders) torque ripple (torque distribution) component. Thus, the 72th-order torque ripple component is decreased more in the rotary electric machine according to the first embodiment of the present invention than in the rotary electric machine according to the comparative embodiment.

In this way, as the torque ripple decreases, noise and vibration decrease during operation of the rotary electric machine.

<Comparison Using Numbers Regarding Torque Ripple>

Here, numbers are used to compare the torque and the torque ripple between the rotary electric machine according to the first embodiment of the present invention and the rotary electric machine according to the comparative embodiment.

The average gap between the rotor and the tip of each tooth of the stator in the rotary electric machine according to the comparative embodiment is set to 0.6 mm.

By contrast, the gaps vary between the rotor and the tips of the teeth in the stator of the rotary electric machine according to the first embodiment of the present invention. That is, as shown in FIG. 1, the gap where the inner diameter R of each tooth 12 is a1 and the gap where the inner diameter R of each tooth 12 is a2 are different in size.

Note that as described previously, the difference between the size (length) of each tooth 12a1, the inner diameter R of which is a1, and the size (length) of each tooth 12a2, the inner diameter R of which is a2, corresponds to the difference between the size (distance) from the bottom of each slot 14 to the tip of each tooth 12a1 and the size (distance) from the bottom of each slot 14 to the tip of each tooth 12a2, whereas the size relationship is opposite.

The gap at the site of each tooth 12a1 (with an inner diameter of a1) is narrower because each tooth is longer and is set to 0.55 mm.

In addition, the gap at the site of each tooth 12a2 (with an inner diameter of a2) is wider because each tooth is shorter and is set to 0.65 mm. The site of each tooth 12a1 (with an inner diameter of a1) and the site of each tooth 12a2 (with an inner diameter of a2) appear alternately, so that the average gap size is 0.6 mm.

As such, the rotary electric machine according to the comparative embodiment and the rotary electric machine according to the first embodiment of the present invention have the same average gap size of 0.6 mm. Thus, the average torque should be the same.

Meanwhile, the rotary electric machine according to the first embodiment of the present invention has a smaller permeance fluctuation of order n, the ordinal number of which is obtained after multiplied by the number of teeth, than that of the comparative embodiment. This makes it possible to decrease, by about 5% experimentally or theoretically, the torque ripple (magnetic pulsation) of order n (12th-order), the ordinal number of which is obtained after multiplied by the number of teeth, while the torque density remains the same.

That is, the torque ripple can be decreased while the average torque is kept at a predetermined value.

### Advantageous Effects of First Embodiment

As describe above, in the first embodiment of the present invention, the permeance fluctuation of order n, the ordinal number of which depends on the shape of teeth, can be suppressed such that the fluctuation of specific order is suppressed by alternately changing the lengths (sizes) of the teeth.

Specifically, an effect of reducing the torque ripple is exerted.

In addition, the reduction of the torque ripple causes high-frequency sound to decrease, leading to effects of making noise lower and vibration smaller.

### OTHER EMBODIMENTS AND MODIFICATION EMBODIMENTS

Note that the present invention is not limited to the above-described embodiment (first embodiment), and various other embodiments and modification embodiments are included.

<<The Number of Variations of Teeth at One Pole>>

The first embodiment is provided with six teeth at one pole. The configuration having three long ones and three short ones has been illustrated.

However, the method for reducing the torque ripple is not limited to this embodiment.

Any (one) of the teeth may have a larger inner diameter. In this case, it may be possible to decrease (suppress) the permeance fluctuation of order n, the ordinal number of which is affected by the number of the teeth.

In addition, not only two different teeth with different lengths but also three or more different teeth may be used to decrease (suppress) the permeance fluctuation of given order.

<<The Number of Teeth at One Pole>>

The first embodiment is provided with six teeth at one pole. The configuration having three long ones and three short ones has been illustrated.

However, the number of teeth at one pole is not limited to six. Depending on the number of poles and/or the configuration of coils (windings), the number of teeth at one pole may be set to a number other than six.

<<The Number of Poles in Rotary Electric Machine>>

Regarding the first embodiment, the case of the rotary electric machine having six pole pairs has been explained. However, in the method described in the first embodiment, the number of pole pairs is not necessarily limited to six. A varied number of pole pairs is applicable.

<<Kinds of Rotary Electric Machine>>

In the first embodiment, the rotary electric machine having six pole pairs has been simply explained.

This rotary electric machine is applicable to electric motors and electric power generators. In addition, the synchronous rotary electric machine is even applicable to induction-type rotary electric machines.

<<Coils (Windings)>>

It has been described in the first embodiment shown in FIG. 1 that each coil (winding) 13 is a distributed winding. However, the effect of suppressing the permeance fluctuation of given order, the ordinal number of which depends on the shape of teeth, is not specific to the distributed winding. For instance, the effect can be exerted by concentrated windings.

### REFERENCE SIGNS LIST

11, 31 Stator
12, 12a1, 12a2, 32 Stator tooth (Tooth)
13, 33 Coil (Winding)
14, 34 Slot
21, 41 Rotor
22, 42 Permanent magnet

1. A rotary electric machine comprising
a stator having a plurality of teeth, slots, and coils at one pole,
wherein a length of one of the teeth from a bottom of each slot to a tip of the one tooth differs from a length of another tooth.

2. The rotary electric machine according to claim 1, wherein the teeth having different lengths from the bottom of each slot to the tip of the corresponding tooth are arranged alternately.

3. The rotary electric machine according to claim 1, wherein six of the teeth are arranged at one pole; and
one pole corresponds to 30 degrees of mechanical angle.

4. The rotary electric machine according to claim 1, wherein each coil arranged in each slot is a distributed winding.

5. The rotary electric machine according to claim 1, wherein the rotary electric machine is an IPM-type rotary electric machine.

6. The rotary electric machine according to claim 1, wherein the rotary electric machine is synchronous.

7. The rotary electric machine according to claim 1, wherein the rotary electric machine is an electric motor.

8. The rotary electric machine according to claim 1, wherein the rotary electric machine is an electric power generator.
